(19) United States
(12) Patent Application Publication
(10) Pub. No.: US 2005/0183554 A1
(43) Pub. Date: Aug. 25, 2005

(54) Method for Sawing Pieces of Wood

(75) Inventors: Georg Reinbold, Maselheim (DE); Herbert Locherer, Laupheim (DE)

Correspondence Address: GUDRUN E. HUCKETT DRAUDT, LONSSTR. 53, WUPPERTAL, 42289, DE

(73) Assignee: GRECON DIMTER HOLZOPTIMIERUNG SUD GMBH + CO. KG, Illertissen (DE)

(21) Appl. No.: 10/709,344

(22) Filed: Apr. 29, 2004

(30) Foreign Application Priority Data
Feb. 24, 2004 (DE) 10 2004 010 334.8

(51) Int. Cl. B26D 7/06

(52) U.S. Cl. 83/13; 83/403.1

(57) ABSTRACT

In a method for sawing pieces of wood in a sawing station, the pieces of wood are measured in a measuring station and sequentially transported from the measuring station to a sawing station. The pieces of wood are sawed in the sawing station into at least two sections based on the measured results taken at the measuring station. A second piece of wood that trails immediately a first piece of wood being cut in the sawing station is already transported into the sawing station while the first piece of wood is still being cut. The feeding velocity of the second piece of wood is selected such that the second piece of wood does not contact the first piece of wood within the sawing station.

### BACKGROUND OF INVENTION

1. Field of the Invention

The invention relates to a method for sawing pieces of wood in a sawing station, wherein the pieces of wood are first measured and, subsequently, based on the measured results, are cut into at least two sections, wherein the pieces of wood are fed sequentially to the sawing station.

2. Description of the Related Art

Measuring of pieces of wood is required in the case of cut-off saws because solid pieces of wood have different qualities and also flaws. Usually, chalk marks are manually applied to the wood for indicating flaws and quality. The length of the pieces of wood is determined in a measuring station or completely automatically by means of a scanner. The collected data are then saved in a computer in a so-called cutting list. The cut-off saw cuts according to this cutting list the pieces of wood into several sections. The distance between the measuring station and the cut-off saw must correspond at least to the maximum length of the pieces of wood to be processed. The pieces of wood are transported by means of a transport belt or a toothed belt through the measuring station and the sawing station. As soon as the piece of wood has been cut in the sawing station, the drive of the transport belt is stopped. Accordingly, the next (trailing) pieces of wood are not transported farther. In this way, the pieces of wood are supplied in a stop-and-go method from the measuring station to the sawing station. The number of pieces of wood that can be processed within a unit of time is relatively low.

### SUMMARY OF INVENTION

It is an object of the present invention to configure the method of the aforementioned kind such that processing of the pieces of wood within a unit of time is optimal.

In accordance with the present invention, this is achieved in that the trailing piece of wood, respectively, is transported into the sawing station already when the leading piece of wood is still being sawed in the sawing station, wherein the feeding velocity of the trailing piece of wood is selected such that the trailing piece of wood does not contact the leading piece of wood in the sawing station.

According to the method of the present intention, the trailing piece of wood is already supplied in the direction toward the sawing station while the preceding or leading piece of wood is still being processed in the sawing station. The feeding velocity of each trailing piece of wood is selected such that it enters the sawing station while the preceding piece of wood is about to leave the sawing station. The feeding velocity is adjusted such that the trailing piece of wood does not contact the piece of wood that is still in the sawing station, on the one hand, but the spacing or distance between these two pieces of wood is minimized, on the other hand. In this way, a very high number of pieces of wood can be processed within a unit of time.

It is advantageous in this connection to control or regulate the feeding velocity of the pieces of wood into the sawing station. In this way, as a function of the processing time within the sawing station, the feeding velocity of the trailing piece of wood can be controlled optimally by means of the control unit.

Prior to being processed in the sawing station, the pieces of wood are advantageously measured with regard to their length and/or with regard to their quality.

Expediently, the measured results or data are saved, advantageously in a computer of the control unit.

Based on the saved data, the feeding velocity of the pieces of wood to the sawing station can be controlled optimally so that the spacing of the pieces of wood relative to one another in the sawing station can be minimized.

In order to enable simple processing, the pieces of wood supplied to the sawing station are transported advantageously without interruption.

Advantageously, the drive for transporting the trailing pieces of wood is decoupled from the drive for the pieces of wood in the sawing station. In this way, the transport of the pieces of wood within the sawing station can be carried out by a stop-and-go method while the supply of pieces of wood to the sawing station is continuous and, optionally, can be carried out at a variable velocity.

### BRIEF DESCRIPTION OF DRAWINGS

FIG. 1 shows a first state of processing carried out in accordance with the method according to the invention.

FIG. 2 shows a second state of processing in accordance with the method of the invention.

FIG. 3 shows a third state of processing in accordance with the method of the invention.

FIG. 4 is a schematic illustration of a control for performing the method according to the invention.

### DETAILED DESCRIPTION

The pieces of wood 1a, 1b, 1c, . . . to be sawed are transported by means of a transport device in the direction of arrow 2 to a sawing station 3. The sawing station 3 has a cut-off saw 4 with which the pieces of wood 1a, 1b, 1c . . . are cut to length transversely, preferably perpendicularly to their transport direction 2. The cut-off saw 4 is provided for this purpose with a saw blade 5 that is moved with a corresponding guide in the vertical direction during the sawing process.

The pieces of wood 1a, 1b, 1c, . . . are first guided through a measuring station 6 where the pieces of wood 1a, 1b, 1c, . . . are measured at least with regard to their length. Since the pieces of wood have different qualities and/or have flaws, they are usually manually marked, for example, by means of chalk marks. In principle, it is also possible to determine the quality, possibly present flaws, and also the length of the pieces of wood 1a, 1b, 1c, . . . by means of a scanner in a fully automated fashion. Since this is known in the art, no further explanation will be given in this context. The measured results or data acquired in this way are saved in a computer in a so-called cutting list based on which the pieces of wood 1a, 1b, 1c, . . . are sawed in the sawing station 3 to the required size, respectively.

The pieces of wood 1a, 1b, 1c, . . . are supplied to the measuring station 6 on a first transport device 7. The transport device 7 can be formed by transport chains, transport belts, toothed belts, or similar devices.

After the pieces of wood 1a, 1b, 1c, . . . have left the measuring station 6, they reach a transfer station 8 through which the pieces of wood 1a, 1b, 1c, . . . are transported to the sawing station 3. The measuring station 6 and the transfer station 8 have the same transport device 7. It has a controllable drive that can be a servo motor or frequency-controlled motor. By means of such a motor it is possible to control or regulate the transport speed in a way to be described in the following as a function of the sawing process in the sawing station 3. In the illustrated embodiment, the measuring station 6 and the sawing station 3 are positioned in a straight line (are aligned). Of course, these two stations 3, 6 can also be arranged so as not to be aligned.

The pieces of wood 1a, 1b, 1c, . . . are transported through the sawing station 3 by means of a second transport device 9 that, like the first transport device 7, can be a transport belt, a transport chain, a toothed belt, rollers or similar devices. The transport device 9 has a second drive (not illustrated) that is of a conventional design known in the art.

The transfer station 8 is the area between the measuring station 6 and the sawing station 3. The length of the transfer station 8 corresponds at least to the maximum length of the pieces of wood 1a, 1b, 1c, . . . to be processed. In the illustrated embodiment, the length of the transfer station 8 is a multiple of the length of the pieces of wood 1a, 1b, 1c . . . . The spacing between the measuring station 6 and the sawing station 3 must be only so great that it matches the maximum length of the pieces of wood. In order to increase the output of the cut-off saw, the supply of the pieces of wood 1a, 1b, 1c, . . . to the sawing station 3 is such that the next (trailing) piece of wood 1b reaches the sawing station 3 when the leading piece of wood 1a has just left the sawing station 3. The spacing or distance between sequentially transported pieces of wood 1a, 1b, 1c, . . . in the sawing station 3 is selected optimally such that the end face of the trailing piece of wood follows at a minimal spacing the trailing end face of the leading piece of wood without having contact with the leading piece of wood. After a small gap has been established between the pieces of wood, both pieces of wood are advantageously transported at the same speed.

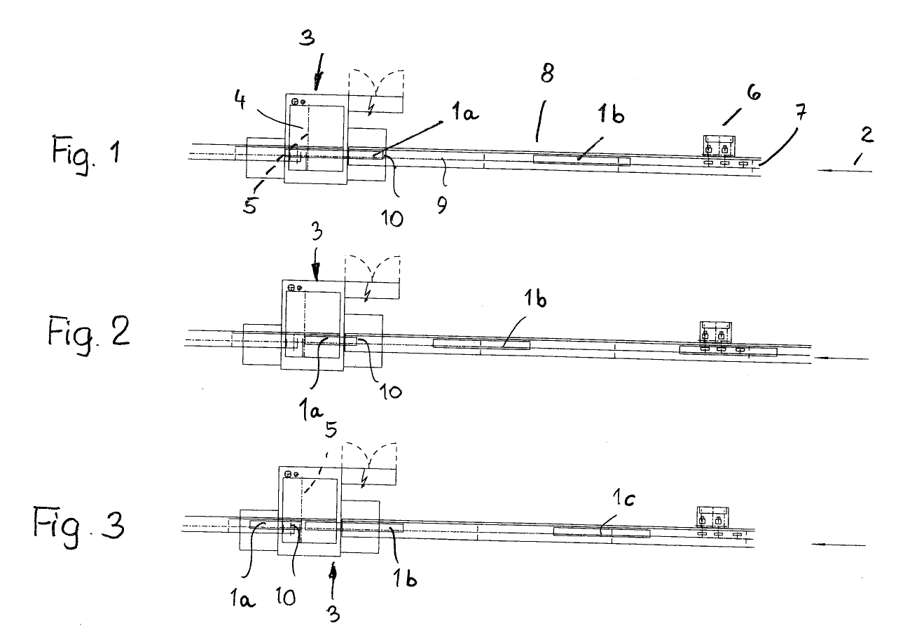

In order for the pieces of wood 1a, 1b, 1c, . . . to enter at a minimal spacing relative to one another the sawing station 3, the drive of the transport device 7 is controlled as a function of the position of the trailing end 10 (viewed in the transport direction 2) of the piece of wood 1a that is positioned within the sawing station 3. FIG. 1 shows the situation where the piece of wood 1a has just entered the sawing station 3 while the trailing piece of wood 1b is already located in the transfer station 8. The piece of wood 1a that is located within the sawing station 3 is cut by the saw blade 5 into several sections in accordance with the previously obtained measured results. After each cut, the piece of wood 1a is transported farther by the appropriate distance. As a result of the decoupling of the drive of the transport device 7 from the drive of the sawing station 3, the trailing piece of wood 1b in the transfer station 8 is transported farther during the sawing process. FIG. 2 shows that the trailing piece of wood 1b has only a minimal spacing from the trailing end 10 of the piece of wood 1a located in the sawing station 3. During the sawing process, the trailing piece of wood 1b is thus supplied advantageously without being stopped to the sawing station 3.

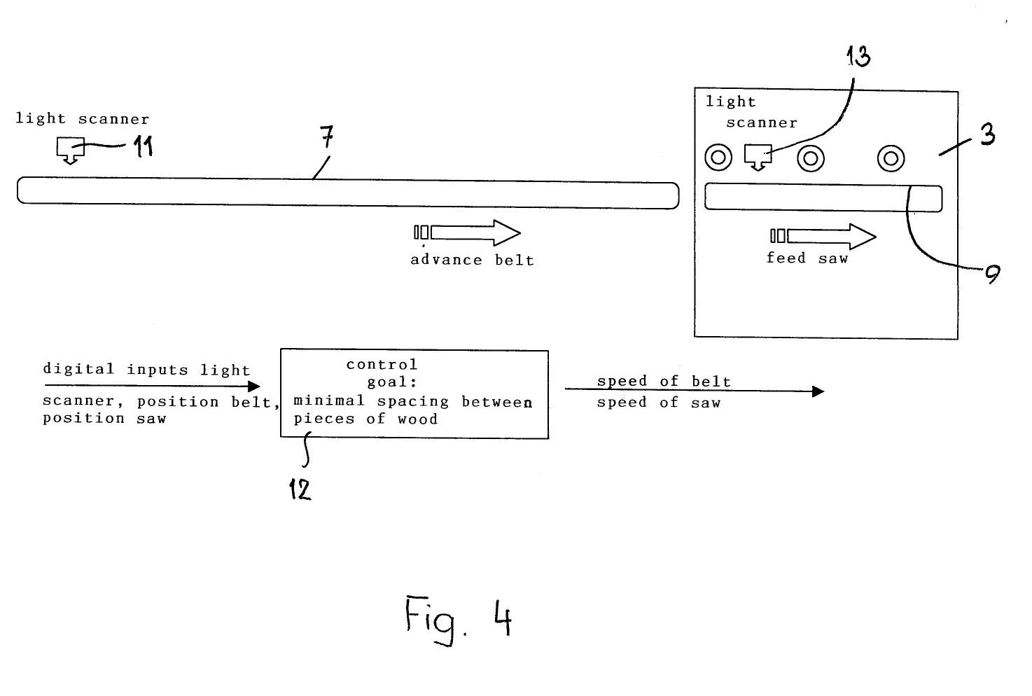

FIG. 3 shows the situation where the trailing end 10 of the last section of the cut piece of wood 1a is positioned downstream of the saw blade 5. The next piece of wood 1b has already been transported into the sawing station 3 and has only a minimal spacing from the trailing end 10 of the leading piece of wood 1a. Accordingly, as soon as the leading piece of wood 1a has left the sawing station 3, the next piece of wood 1b can be directly sawed. While this piece of wood 1b is now being cut in the sawing station 3, the next piece of wood 1c is supplied as described above.

The speed at which the trailing piece of wood 1b, 1c, . . . is supplied from the measuring station 6 or the transfer station 8 is controlled such that the gaps between the sequentially transported pieces of wood 1a, 1b, 1c, . . . has a minimum in the sawing station 3. The pieces of wood 1a, 1b, 1c, . . . are advantageously continuously transported on the transport device 7, wherein the transport (feeding) velocity can be varied.

Since the processing time of the pieces of wood 1 in the sawing station 3 varies greatly depending on the number of cuts to be performed, the velocity of the trailing pieces of wood 1b, 1c, . . . is adjusted accordingly. Since the length as well as the flaw and quality markings of the pieces of wood 1a, 1b, 1c, . . . are present in the cutting list within the computer, the control based on this cutting list can exactly adjust the transport or feeding velocity of the transport device 7 so that the spacings between sequentially transported pieces of wood 1a, 1b, 1c, . . . in the sawing station 3 can be reduced to a minimum. Depending on the processing time in the sawing station 3, it is also possible to interrupt the transport of the trailing pieces of wood 1a, 1b, 1c, . . . .

The transport of pieces of wood 1a, 1b, 1c, . . . through the measuring station 6 and the transfer station 8 is carried out at different feeding velocities that are determined by means of an intelligent control. The position of the pieces of wood 1s, 1b, 1c, . . . in the measuring station 6, in the transfer station 8, as well as in the sawing station 3 is monitored by means of a distance measuring system that detects both ends of the pieces of wood 1a, 1b, 1c, . . . , respectively.

As illustrated schematically in FIG. 4, the position of the pieces of wood 1 on the transport device 7 is detected, for example, by means of a light scanner 11 whose signals are supplied to the control unit 12. In the area of the advancing direction 9 in the sawing station 3 an additional light scanneris positioned whose signals are also supplied to the control unit 12. The input signals of the two light scanners 11, 13 indicate positions of the transport devices or of the pieces of wood 1a, 1b, 1c, . . . as well as the position of the saw. Based on the input signals, the feeding velocity of the transport devices 7, 9 as well as the speed of the saw are recalculated and adjusted such that sequentially transported pieces of wood 1, 1b, 1c, . . . have a minimal spacing relative to one another.

The measured results or values as well as the speed of the transport devices 7, 9 are supplied to the computer, i.e., the control unit. Based on these values, the control unit evaluates continuously the positions of the leading and trailing ends of the pieces of wood 1a, 1b, 1c, . . . relative to one another. The required feeding velocity of the trailing piece of wood 1b, 1c, . . . , respectively, is variably controlled wherein the feeding velocity is computed continuously anew within the control unit. In the way described, the measured and saved values are used for controlling the feeding velocity. In this way, the spacing between sequentially transported pieces of wood 1a, 1b, 1c, . . . during their transport to the sawing station 3 can be minimized.

While specific embodiments of the invention have been shown and described in detail to illustrate the inventive principles, it will be understood that the invention may be embodied otherwise without departing from such principles.

1. A method for sawing pieces of wood in a sawing station, the method comprising the steps of:
a) measuring the pieces of wood in a measuring station;
b) sequentially transporting the pieces of wood from the measuring station to a sawing station;
c) cutting the pieces of wood in the sawing station into at least two sections based on measured results taken in step a);
wherein in the step b) a second piece of wood that trails immediately a first piece of wood being cut in the sawing station is already transported into the sawing station while the first piece of wood is still being cut;
wherein in the step b) a feeding velocity of the second piece of wood is selected such that the second piece of wood does not contact the first piece of wood within the sawing station.

2. The method according to claim 1, comprising the step of controlling the feeding velocity of the second piece of wood.

3. The method according to claim 2, wherein, in the step of controlling, the feeding velocity of the second piece of wood is controlled variably.

4. The method according to claim 2, wherein, in the step of controlling, the feeding velocity of the second piece of wood is continuously recalculated in a control unit.

5. The method according to claim 4, further comprising the step of continuously monitoring a position of the pieces of wood, wherein the control unit recalculates the feeding velocity based on the continuously monitored positions of the pieces of wood.

6. The method according to claim 2, wherein a feeding velocity of the second piece of wood is controlled so as to minimize a between the first and second pieces of wood.

7. The method according to claim 1, wherein, in the step a), a length of the pieces of wood is measured.

8. The method according to claim 1, wherein, in the step a), a quality of the pieces of wood is measured.

9. The method according to claim 1, further comprising the step of saving the measured results.

10. The method according to claim 9, further comprising the step of controlling the feeding velocity of the second piece of wood, wherein the measured results that are saved are used for controlling the feeding velocity.

11. The method according to claim 1, wherein in the step b) the second pieces of wood are supplied without interruption to the sawing station.

12. The method according to claim 1, further comprising the step of decoupling a drive for transporting the pieces of wood to the sawing station from a drive of the sawing station.
